(19) United States
(12) Patent Application Publication
(10) Pub. No.: US 2026/0357104 A1
(43) Pub. Date: Nov. 12, 2026

(54) 3D PRINTER MODELING MATERIAL AND MODELED OBJECT

(71) Applicant: ZEON Corporation, Tokyo (JP)

(72) Inventor: Arinobu Katada, Tokyo (JP)

(73) Assignee: ZEON Corporation, Tokyo (JP)

(21) Appl. No.: 19/129,894

(22) PCT Filed: Oct. 27, 2023
(86) PCT No.: PCT/JP2023/038881

§ 371 Date: May 14, 2025

(30) Foreign Application Priority Data
Nov. 15, 2022 (JP) 2022-182806

(51) Int. Cl. C09D 167/04; B29C 64/118; B29K 67/00; B29K 105/16; B29L 31/30; B33Y 10/00; B33Y 70/10; B33Y 80/00

(52) U.S. Cl. CPC C09D 167/04; B33Y 70/10; B33Y 80/00; B29C 64/118; B29K 2067/046; B29K 2105/165; B29K 2995/0063; B29K 2995/007; B29L 2031/3076; B33Y 10/00

(57) ABSTRACT

Provided is a 3D-printer modeling material used in 3D-printer modeling by fused deposition modeling, wherein the 3D-printer modeling material comprises a matrix polymer and a hollow particle, the 3D-printer modeling material has an apparent density at 20 °C of 0.9 g/cm³ or less, and the 3D-printer modeling material shows a shore A hardness of 61 to 98 at a time point of 15 seconds from the start of indentation, the shore A hardness being determined in accordance with JIS K 6253-3:2012.

### TECHNICAL FIELD

The present invention relates to a 3D-printer modeling material and a modeled body.

### BACKGROUND ART

Recently, 3D-printer modeling techniques (three-dimensional modeling techniques) have received attention as a method for producing a resin modeled body. Such 3D-printer modeling techniques allow great freedom of design so that a variety of modeled bodies having complex three-dimensional geometries can be produced, and can also reduce time and costs needed for design. Thus, 3D-printer modeling techniques have been increasingly used in significantly broad applications.

Here, constituent components of aerial systems such as drones often have complex three-dimensional shapes, and may be produced by a 3D-printer modeling technique in some cases. In the constituent components of aerial systems, a reduction in weight is required from the viewpoint of improving the driving time of the aerial systems, and high flexibility is also required from the viewpoint of impact absorption properties and prevention of breakage by dropping or collision. For this reason, a 3D-printer modeling material which can attain the above properties has been demanded.

For example, Patent Document 1 discloses a filament used as a raw material for a print material to be printed by a three-dimensional printer using fused deposition modeling (FDM), wherein the filament comprises a polylactic acid resin and a thermoplastic elastomer.

### RELATED ART DOCUMENTS

### Patent Documents

Patent Document 1: JP 2017-136739 A

### SUMMARY OF THE INVENTION

### Problem to be Solved by the Invention

When constituent components of aerial systems such as drones are produced by a 3D-printer modeling technique, what is required is that lightweight modeled bodies having high flexibility can be produced with high modeling efficiency. However, as a result of research, the present inventor has found that a modeled body obtained from the filament disclosed in Patent Document 1 has a large apparent density, and the filament has difficulties in producing a modeled body having high flexibility with high modeling efficiency.

Thus, an object of the present invention is to provide a 3D-printer modeling material which allows production of a lightweight modeled body having high flexibility with high modeling efficiency.

### Means for Solving Problems

The present inventor, who has conducted extensive research to achieve the above object, has found that the above object can be achieved by adding a hollow particle to a 3D-printer modeling material and controlling the apparent density of the 3D-printer modeling material and the shore A hardness thereof within specific ranges, and has completed the present invention.

Specifically, the present invention provides a 3D-printer modeling material and a modeled body as follows.
[1] A 3D-printer modeling material used in 3D-printer modeling by fused deposition modeling,
   wherein the 3D-printer modeling material comprises a matrix polymer and a hollow particle,
   the 3D-printer modeling material has an apparent density at 20 °C of 0.9 g/cm³ or less, and
   the 3D-printer modeling material shows a shore A hardness of 61 to 98 at a time point of 15 seconds from the start of indentation, the shore A hardness being determined in accordance with JIS K 6253-3:2012.
[2] The 3D-printer modeling material according to [1], wherein the 3D-printer modeling material is filament-shaped.
[3] The 3D-printer modeling material according to [1] or [2], wherein the 3D-printer modeling material contains a thermoplastic elastomer as the matrix polymer.
[4] The 3D-printer modeling material according to any one of [1] to [3], wherein the 3D-printer modeling material contains a thermoplastic plastomer and a thermoplastic elastomer as the matrix polymer.
[5] The 3D-printer modeling material according to any one of [1] to [4], wherein the 3D-printer modeling material contains a cross-linked hollow particle as the hollow particle.
[6] The 3D-printer modeling material according to any one of [1] to [5], wherein the matrix polymer has a density at 20 °C of 0.91 to 1.3 g/cm³.
[7] The 3D-printer modeling material according to any one of [1] to [6], wherein the hollow particle has an apparent density at 20 °C of 0.2 to 0.8 g/cm³.
[8] The 3D-printer modeling material according to any one of [1] to [7], wherein the amount of the hollow particle contained is 1 to 50 parts by mass relative to 100 parts by mass of the total amount of the matrix polymer and the hollow particle contained.
[9] A modeled body formed from 3D-printer modeling material according to any one of [1] to [8], wherein when the modeled body is measured for shore A hardness in accordance with JIS K 6253-3:2012, the shore A hardness at a time point of 15 seconds from the start of indentation is 61 to 98.
[10] The modeled body according to [9], wherein the modeled body is a constituent component for an aerial system.

### Effects of the Invention

The present invention provides a 3D-printer modeling material which allows production of a lightweight modeled body having high flexibility with high modeling efficiency.

### DESCRIPTION OF EMBODIMENTS

### <3D-Printer Modeling Material>

The 3D-printer modeling material according to the present invention is a 3D-printer modeling material used in 3D-printer modeling by fused deposition modeling,
wherein the 3D-printer modeling material comprises a matrix polymer and a hollow particle,
the 3D-printer modeling material has an apparent density at 20 °C of 0.9 g/cm³ or less, and
the 3D-printer modeling material shows a shore A hardness of 61 to 98 at a time point of 15 seconds from the start of indentation, the shore A hardness being determined in accordance with JIS K 6253-3:2012.

The 3D-printer modeling material according to the present invention allows production of a lightweight modeled body having high flexibility, and specifically allows production of a modeled body having a small apparent density and large maximum-point flexural strain. Furthermore, the 3D-printer modeling material according to the present invention allows production of such a modeled body with high modeling efficiency. Specifically, use of the 3D-printer modeling material according to the present invention can suppress generation of die drool (aggregates near the ejection port) during 3D-printer modeling by fused deposition modeling, can suppress clogging of the nozzle, and allows production of a modeled body having a good appearance while a rough skin (roughened surface of the modeled body) is suppressed.

### [Matrix Polymer]

The 3D-printer modeling material according to the present invention comprises a matrix polymer.

The matrix polymer can be any matrix polymer as long as it can be used in 3D-printer modeling and it can give the 3D-printer modeling material according to the present invention having a specific apparent density and shore A hardness. Examples of the matrix polymer include thermoplastic plastomers and thermoplastic elastomers.

The plastomer refers to a material which demonstrates no or almost no elastic deformation and easily undergoes plastic deformation. On the other hand, the elastomer refers to a material which instantaneously deforms in response to an external force when the external force is applied, and restores to the original shape in a short time when the external force is removed. Thus, the elastomer is in contrast to the former material.

In the present disclosure, the term “thermoplastic plastomer” refers to a polymer which easily flows and deforms by heating, and can be solidified in a deformed shape by cooling.

In the present disclosure, such a thermoplastic plastomer to be used is typically a material which can be stretched to 200% with a small external force at room temperature (20 °C) in a tensile test when the original dimension is regarded as 100%, and does not restore to less than 130% after the external force is removed. A small external force specifically refers to an external force of 1 to 100 MPa as tensile strength. More specifically, the thermoplastic plastomer to be used can be a polymer which can be stretched without breakage such that the gauge length of a test piece, which is a #4 dumbbell-shaped test piece specified in JIS K 6251-1993, is stretched to twice the gauge length before stretching in a tensile test at 20 °C based on a tensile permanent strain test in accordance with JIS K 6262-1997, and has a tensile permanent strain of 30% or more after 5 minutes from removal of the tensile external force after stretching to twice the gauge length before stretching and then holding the length for 60 minutes.

Generally, the elastomer refers to a material which instantaneously deforms in response to an external force when the external force is applied, and restores to the original shape in a short time when the external force is removed. Generally, the thermoplastic elastomer refers to a material which demonstrates rubber elasticity at ambient temperature (25 °C) and can be plasticized and molded at a high temperature.

In the present disclosure, the thermoplastic elastomer to be used is typically a material which can be deformed to 200% with a small external force at room temperature (20 °C) where the original dimension is regarded as 100%, and restores to less than 130% after the external force is removed. The small external force specifically refers to an external force of 1 to 100 MPa as tensile strength. More specifically, the thermoplastic elastomer to be used can be a polymer which can be stretched without breakage such that the gauge length of a test piece, which is a #4 dumbbell-shaped test piece specified in JIS K 6251-1993, is stretched to twice the gauge length before stretching in a tensile test at 20 °C based on a tensile permanent strain test in accordance with JIS K 6262-1997, and has a tensile permanent strain of less than 30% after 5 minutes from removal of the tensile external force after stretching to twice the gauge length before stretching and then holding the length for 60 minutes.

Specific examples of the thermoplastic plastomer include acrylonitrile-butadiene-styrene resins (ABS resins); acrylonitrile-styrene resins (AS resins); polylactic acid resins (PLA resins); polyolefin resins such as polypropylene and polyethylene; polyamide resins such as PA6, PA66, and PA12; polyimide resins such as polyimide, polyamideimide, and polyether imide; polycarbonate resins; polystyrene resins; fluorine-containing resins such as polyvinylidene fluoride and polytetrafluoroethylene; polyester resins; acrylic resins; polyvinyl chloride resins; polyether ketone ketone; poly(meth)acrylates; polyphenylene ether; polyphenylene sulfide; silicone resins; and the like. These thermoplastic plastomers can be used alone or in combination. Among these, preferred are polylactic acid resins (PLA resins) because the apparent density and shore A hardness of the 3D-printer modeling material can be easily controlled within suitable ranges described later, thermal shrinkage during modeling can be reduced, the modeling efficiency can be further enhanced, and a modeled body having enhanced mechanical strength can be obtained.

The polylactic acid resin (PLA resin) is a synthetic resin generated by polymerization of lactic acid with an ester bond, and usually has a melting point of about 170 °C and a shore A hardness of 100. The polylactic acid resin (PLA resin) is preferably a resin which has a purity of 95% or more and may contain 5% or less of additives. In the polylactic acid resin (PLA resin), the D form content is preferably 1.0 mol % or less or 99.0 mol % or more, more preferably 0.1 to 0.6 mol % or 99.4 to 99.9 mol %. When the D form content falls within the above ranges, high crystallinity is provided. Thus, higher modeling efficiency can be obtained (modeling cycle can be shortened) and a modeled body having enhanced heat resistance can be obtained.

Specific examples of polymers forming the thermoplastic elastomer include olefin elastomers, styrene elastomers, and the like.

The olefin elastomer is not particularly limited. Preferred are propylene elastomers in which polyethylene-polypropylene rubber (EPDM, EPM) is finely dispersed in polypropylene.

The styrene elastomer is preferably a block copolymer containing a polystyrene block as a hard segment and a conjugated diene polymer block as a soft segment. Such a block copolymer usually demonstrates physical properties like a cross-linked rubber when the temperature is low, and when heated, is melted by heating and demonstrates fluidity. The conjugated diene polymer block may be at least partially hydrogenated, or may be unhydrogenated. Examples of the block copolymer containing a polystyrene block and a conjugated diene polymer block include styrene-butadiene-styrene block copolymer (SBS), styrene-isoprene-styrene block copolymer (SIS), styrene-ethylene/butylene-styrene block copolymer (SEBS), styrene-ethylene/propylene-styrene block copolymer (SEPS), partially hydrogenated styrene-ethylene/butylene-styrene block copolymer (partially hydrogenated SEBS), styrene·(ethylene-ethylene/propylene)-styrene block copolymer (SEEPS), and the like. Among these, preferred are styrene-ethylene/butylene-styrene block copolymer (SEBS) and styrene·(ethylene-ethylene/propylene)-styrene block copolymer (SEEPS).

As the thermoplastic elastomer, preferred are styrene elastomers, and more preferred are block copolymers containing a polystyrene block and a conjugated diene polymer block because these can facilitate control of the apparent density and shore A hardness of the 3D-printer modeling material within suitable ranges described later and a modeled body having higher flexibility can be produced with higher modeling efficiency.

The weight average molecular weight of the polymer contained in the thermoplastic elastomer is preferably 100,000 or more and 200,000 or less from the viewpoint of the mechanical strength of a modeled body to be obtained, although the weight average molecular weight is not particularly limited thereto.

In the present invention, when the thermoplastic elastomer is used as the matrix polymer, preferably, the 3D-printer modeling material according to the present invention contains a thermoplastic elastomer containing a plasticizer. Specific examples of the plasticizer to be used include mineral oil-based plasticizers of paraffinic oil, naphthenic oil, or higher fatty acid. For example, when the styrene elastomer is used as the polymer contained in the thermoplastic elastomer, it is preferred that a refined petroleum paraffin-based hydrocarbon oil containing paraffin as a main component be used as the plasticizer because it has favorable compatibility with the styrene elastomer. When the 3D-printer modeling material according to the present invention contains the thermoplastic elastomer containing a plasticizer, the mass ratio of the content of the polymer contained in the thermoplastic elastomer to the content of the plasticizer, “polymer contained in the thermoplastic elastomer/plasticizer”, is preferably 25/75 to 30/70.

The thermoplastic elastomer preferably has a melting point in the range of 100 to 170 °C.

The 3D-printer modeling material according to the present invention preferably contains the thermoplastic elastomer as the matrix polymer, and more preferably contains both of the thermoplastic plastomer and the thermoplastic elastomer.

When the 3D-printer modeling material contains both of the thermoplastic plastomer and the thermoplastic elastomer, the content of the thermoplastic elastomer (including the plasticizer when the thermoplastic elastomer contains the plasticizer) in the total amount of the thermoplastic plastomer and the thermoplastic elastomer in the 3D-printer modeling material is preferably 9.1 to 90.1% by mass, more preferably 20 to 85% by mass, still more preferably 30 to 80% by mass, although not particularly limited thereto. When the content of the thermoplastic elastomer falls within the above ranges, the modeling efficiency can be further enhanced, and a modeled body having mechanical strength and flexibility in a better balance can be obtained.

When higher flexibility is required, the content of the thermoplastic elastomer in the total amount of the thermoplastic plastomer and the thermoplastic elastomer is particularly preferably 50 to 80% by mass, most preferably 65 to 80% by mass.

The density at 20 °C (true density) of the matrix polymer used in the present invention can be a density which can provide a 3D-printer modeling material according to the present invention having a specific apparent density, and is not particularly limited. The density at 20 °C (true density) is preferably 0.91 to 1.3 g/cm³, more preferably 0.92 to 1.2 g/cm³, still more preferably 0.93 to 1.1 g/cm³.

The matrix polymer used in the present invention preferably has a melting point in the range of 100 to 170 °C.

When the matrix polymer used in the present invention is measured for shore A hardness in accordance with JIS K 6253-3:2012, the shore A hardness at a time point of 15 seconds from the start of indentation is preferably less than 61, more preferably 30 to 60.

When the matrix polymer used in the present invention is measured for shore A hardness in accordance with JIS K 6253-3:2012, the recovery rate of the shore A hardness is preferably 0.01 to 0.4, more preferably 0.1 to 0.3, the recovery rate being determined by dividing the difference between the shore A hardness immediately after the start of indentation and the shore A hardness at a time point of 15 seconds from the start of indentation by 15 seconds.

### [Hollow Particle]

The 3D-printer modeling material according to the present invention comprises a hollow particle in addition to the above-mentioned matrix polymer.

The hollow particle used in the present invention is a particle including a shell (outer shell) and a hollow portion surrounded by the shell. Here, the hollow portion is a hollow space clearly distinguished from the shell of the hollow particle. The hollow portion may be filled with a gas such as air, or may contain a solvent. Although the hollow particle used in the present invention may have one or two or more hollow portions, preferred is a hollow particle having only one hollow portion to maintain a high void ratio and mechanical strength at a favorable balance.

In the hollow particle used in the present invention, usually, the shell has no communication holes and shell defects, and the hollow portion is isolated from the outside of the particle by the shell. However, the shell may have one or two or more communication holes, and the hollow portion may be in communication with the outside of the particle through the communication hole(s). The shell of the hollow particle and a partition dividing adjacent hollow portions, when two or more hollow portions are present, may be porous. In this case, the hollow portion(s) has (have) a size large enough to be clearly distinguished from a large number of fine spaces homogeneously dispersed inside the porous structure. The hollow particle used in the present invention may be subjected to a known surface treatment such as a boron treatment, a surface coupling treatment, fluorine coating, or diamond coating.

Although the hollow particle can have any external shape without limitation, preferred is a spherical shape because such an outer shape allows further enhancement in modeling efficiency and a modeled body having mechanical strength and flexibility in a better balance can be obtained. The external shape of the hollow particle can be verified by observing the particle with an SEM or a TEM. The internal shape of the hollow particle can be verified by SEM observation of a cross-section of the particle or TEM observation of the particle, for example.

Examples of the hollow particle to be used include inorganic hollow particles, organic hollow particles, organic inorganic composite hollow particles, and the like. Among these, preferred is use of an organic hollow particle because adhesiveness between the strand ejected first and that ejected thereon can be enhanced when 3D-print modeling is performed by fused deposition modeling using the 3D-printer modeling material, the modeling efficiency can be further enhanced, and a modeled body having mechanical strength and a flexibility in a better balance can be obtained.

Examples of inorganic hollow particles include ceramic hollow particles containing an Si-based oxide component (such as silica) or an Al-based oxide component (such as alumina), such as glass balloon, glass bubbles, fly ash balloon, Shirasu balloon, silica balloon, and aluminosilicate balloon. Glass balloon and glass bubbles can be produced by blowing air to a melted material while dropping the material. Fly ash balloon and Shirasu balloon can be produced by a gas generated when a mineral is melted by heating. The ceramic hollow particles can be produced by forming a ceramic on the outside of a template, such as oil droplets of an O/W emulsion or polystyrene beads, by a sol-gel method, and removing the template.

Examples of organic hollow particles include thermoplastic plastomer particles and thermosetting resin particles. Examples of thermoplastic plastomers which can be used as the hollow particle include organic hollow particles including a shell formed from a homopolymer of a monomer selected from monomers having a styrene skeleton (such as styrene, parachlorostyrene, and «-methylstyrene), monomers having an (meth)acryloyl group (such as acrylic acid, methacrylic acid, (meth)acrylic acid esters (methyl acrylate, ethyl acrylate, n-propyl acrylate, n-butyl acrylate, lauryl acrylate, nitrile acrylate, 2-ethylhexyl acrylate, methyl methacrylate, ethyl methacrylate, n-propyl methacrylate, lauryl methacrylate, and 2-ethylhexyl methacrylate)), vinyl acetate, vinyl ethers (such as vinyl methyl ether and vinyl isobutyl ether), vinyl ketone (such as vinyl methyl ketone, vinyl ethyl ketone, and vinyl isopropenyl ketone), olefins (such as ethylene, propylene, and butadiene), or a copolymer of these monomers in combination.

Examples of the organic hollow particles also include organic hollow particles including a shell formed from a non-vinyl resin (such as epoxy resin, polyester resin, polyurethane resin, polyamide resin, polyamide resin, cellulose resin, polyether resin, or modified rosin), a mixture of these and the vinyl resin described above, or a graft polymer obtained by polymerization of a vinyl monomer under the co-presence of these.

Besides, examples of the organic hollow particles also include cross-linked hollow particles comprising a resin containing a cross-linkable monomer unit. Preferred is use of a cross-linked hollow particle as the hollow particle because the hollow shape derived from the hollow particle can be favorably maintained and the effect caused by addition of the hollow particle can be more effectively obtained during production of the 3D-printer modeling material and 3D-printer modeling using the 3D-printer modeling material, and further, a modeled body having high mechanical strength can be obtained. Hereinafter, a suitable cross-linked hollow particle will be described.

The outer shell of the cross-linked hollow particle comprises a resin formed from a shell polymer containing a cross-linkable monomer unit. The shell polymer is a polymer used to form the shell of the hollow particle, and contains a cross-linkable monomer unit. The cross-linkable monomer forming a cross-linkable monomer unit has two or more polymerizable functional groups and forms a cross-linking bond in the resin by a polymerization reaction. As the cross-linkable monomer, a compound having at least one ethylenically unsaturated bond as a polymerizable functional group is generally used.

Examples of the cross-linkable monomer forming a cross-linkable monomer unit include cross-linkable hydrocarbon monomers and heteroatom-containing cross-linkable monomers.

Examples of the cross-linkable hydrocarbon monomers include, but are not particularly limited to, bifunctional cross-linkable hydrocarbon monomers such as divinylbenzene, divinyldiphenyl, divinylnaphthalene, dicyclopentadiene, and ethylidene tetracyclododecene. Among these, divinylbenzene is preferred. Besides, cross-linkable hydrocarbon monomers composed of a polymer can also be used. Examples thereof include polybutadiene, polyisoprene, styrene-butadiene block copolymer (SBS), styrene-isoprene block copolymer (SIS), and the like.

Examples of the heteroatom-containing cross-linkable monomers include, but are not particularly limited to, bifunctional heteroatom-containing cross-linkable monomers such as diallyl phthalate, allyl (meth)acrylate [indicating allyl acrylate and/or allyl methacrylate. Hereinafter, the same is applied.], ethylene glycol di(meth)acrylate, and pentaerythritol di(meth)acrylate; tri- or higher functional heteroatom-containing cross-linkable monomers such as trimethylolpropane tri(meth)acrylate, ditrimethylolpropane tetra(meth)acrylate, pentaerythritol tri(meth)acrylate, pentaerythritol tetra(meth)acrylate, ethoxified pentaerythritol tetra(meth)acrylate, dipentaerythritol hexa(meth)acrylate, and dipentaerythritol poly(meth)acrylate; and the like.

Other examples of the heteroatom-containing cross-linkable monomers to be used include polyisocyanate compounds such as tolylene diisocyanate, xylylene diisocyanate, diphenylmethane diisocyanate, hexamethylene diisocyanate, trimethylhexamethylene diisocyanate, tetramethylxylylene diisocyanate, isophorone diisocyanate (IPDI), hydrogenated tolylene diisocyanate, hydrogenated xylylene diisocyanate, hydrogenated diphenylmethane diisocyanate, m-phenylene diisocyanate, biphenylene diisocyanate, tetramethylene diisocyanate, hexamethylene diisocyanate, and dimers or trimers thereof. Further, polyfunctional urethane (meth)acrylate compounds obtained by a reaction of a polyisocyanate compound with a hydroxyl group-containing (meth)acrylate having a hydroxyl group and an (meth)acryloyl group can also be used. Specific examples of hydroxyl group-containing (meth)acrylates include hydroxyalkyl (meth)acrylates such as 2-hydroxyethyl (meth)acrylate, 2-hydroxypropyl (meth)acrylate, 4-hydroxybutyl (meth)acrylate, pentaerythritol tri(meth)acrylate, trimethylolpropane di(meth)acrylate, and dipentaerythritol penta(meth)acrylate; and isocyanuric acid di(meth)acrylic acid esters, ethylene oxides thereof, and caprolactone-modified products thereof.

Among these, as the heteroatom-containing cross-linkable monomer, ethylene glycol di(meth)acrylate, trimethylolpropane tri(meth)acrylate, pentaerythritol tetra(meth)acrylate, dipentaerythritol poly(meth)acrylate, and pentaerythritol tri(meth)acrylate are preferred, ethylene glycol di(meth)acrylate, trimethylolpropane tri(meth)acrylate, and pentaerythritol tetra(meth)acrylate are more preferred, and ethylene glycol dimethacrylate, trimethylolpropane trimethacrylate, and pentaerythritol tetramethacrylate are still more preferred.

As the cross-linkable monomer, the cross-linkable hydrocarbon monomers, ethylene glycol di(meth)acrylate, trimethylolpropane tri(meth)acrylate, pentaerythritol tetra(meth)acrylate, dipentaerythritol poly(meth)acrylate, and pentaerythritol tri(meth)acrylate are preferred, divinylbenzene, ethylene glycol di(meth)acrylate, trimethylolpropane tri(meth)acrylate, and pentaerythritol tetra(meth)acrylate are more preferred, and divinylbenzene, ethylene glycol dimethacrylate, trimethylolpropane trimethacrylate, and pentaerythritol tetramethacrylate are still more preferred.

These cross-linkable monomers can be used alone or in combination. In the cross-linked hollow particle, the shell polymer preferably contains a bifunctional cross-linkable monomer unit and a tri- or higher cross-linkable monomer, more preferably contains a bifunctional cross-linkable monomer unit and a tri- or higher heteroatom-containing cross-linkable monomer unit, and still more preferably contains a bifunctional heteroatom-containing cross-linkable monomer unit and a tri- or higher heteroatom-containing cross-linkable monomer unit. Although the tri- or higher cross-linkable monomer is not particularly limited, tri- to hexafunctional cross-linkable monomers are preferred, tri- to pentafunctional cross-linkable monomers are more preferred, and tri- to tetrafunctional cross-linkable monomers are still more preferred. In the cross-linked hollow particle, the shell polymer can also contain a cross-linkable hydrocarbon monomer unit and a heteroatom-containing cross-linkable monomer unit.

The shell polymer may be composed of substantially only a cross-linkable monomer unit, or may contain a monofunctional monomer unit in addition to the cross-linkable monomer unit.

The monofunctional monomer forming a monofunctional monomer unit is a monomer having only one polymerizable functional group. A compound having an ethylenically unsaturated bond as the polymerizable functional group is generally used. Examples of the monofunctional monomer forming a monofunctional monomer unit include monofunctional hydrocarbon monomers and heteroatom-containing monofunctional monomers.

Examples of the monofunctional hydrocarbon monomers include, but are not particularly limited to, aromatic vinyl monomers such as styrene, ethylvinylbenzene, vinyltoluene, «-methylstyrene, p-methylstyrene, and halogenated styrene; monoolefin monomers such as ethylene, propylene, butylene, and 4-methyl-1-pentene; diene monomers such as butadiene and isoprene; and the like. Among these, styrene and ethylvinylbenzene are preferred.

Examples of the heteroatom-containing monofunctional monomers include, but are not particularly limited to, hydrophilic monofunctional monomers; acrylic monovinyl monomers such as methyl (meth)acrylate, ethyl (meth)acrylate, butyl (meth)acrylate, 2-ethylhexyl (meth)acrylate, lauryl (meth)acrylate, and glycidyl (meth)acrylate; carboxylic acid vinyl ester monomers such as vinyl acetate; vinyl halide monomers such as vinyl chloride; vinylidene halide monomers such as vinylidene chloride; vinylpyridine monomers; urethane (meth)acrylate and allyl glycidyl ether; and the like.

The hydrophilic monofunctional monomers preferably have solubility in water of 1% by mass or more. Examples of such hydrophilic monofunctional monomers include, but are not particularly limited to, monofunctional monomers having a hydrophilic group, such as acid group-containing monomers, hydroxyl group-containing monomers, amide group-containing monomers, and polyoxyethylene group-containing monomers.

The acid group-containing monomer indicates a monomer containing an acid group. The acid group herein includes both of proton donating groups (Bronsted acid groups) and electron-pair receiving groups (Lewis acid groups). The acid group-containing monomer is not particularly limited as long as it has an acid group. Examples thereof include carboxyl group-containing monomers, sulfonic acid group-containing monomers, and the like. Examples of the carboxyl group-containing monomers include ethylenically unsaturated carboxylic acid monomers such as acrylic acid, methacrylic acid, crotonic acid, cinnamic acid, itaconic acid, fumaric acid, maleic acid, and butene tricarboxylic acid; monoalkyl esters of unsaturated dicarboxylic acids such as monoethyl itaconate, monobutyl fumarate, and monobutyl maleate; and the like. Examples of the sulfonic acid group-containing monomers include styrenesulfonic acid and the like.

Examples of the hydroxyl group-containing monomer include 2-hydroxyethyl (meth)acrylate, 2-hydroxypropyl (meth)acrylate, 4-hydroxybutyl (meth)acrylate, and the like.

Examples of the amide group-containing monomer include acrylamide, dimethylacrylamide, and the like.

Examples of the polyoxyethylene group-containing monomer include methoxy polyethylene glycol (meth)acrylate, and the like.

These monofunctional monomer units can be used alone or in combination.

The content of the cross-linkable monomer unit in the shell polymer is preferably 20 to 100% by mass, more preferably 40 to 100% by mass, still more preferably 60 to 100% by mass, particularly preferably 80 to 100% by mass, but not particularly limited thereto. When the content of the cross-linkable monomer falls within the above ranges, a covalent bond network is densely formed in the shell, and generation of communication holes of the shell and shell defects is suppressed. As a result, the effect caused by addition of the hollow particle can be more effectively demonstrated in the 3D-printer modeling material according to the present invention, and a modeled body having enhanced mechanical strength can also be obtained.

The content of the monofunctional monomer unit in the shell polymer is not particularly limited. Since the effect caused by addition of the hollow particle can be more effectively demonstrated, the proportion is preferably 0 to 80% by mass, more preferably 0 to 60% by mass, still more preferably 0 to 40% by mass, particularly preferably 0 to 20% by mass.

The hell polymer may contain a heteroatom-containing monomer unit. Examples of the heteroatom-containing monomer forming a heteroatom-containing monomer unit include the heteroatom-containing cross-linkable monomers and the heteroatom-containing monofunctional monomers listed above. The content of the heteroatom-containing monomer unit in the shell polymer is preferably 1 to 99% by mass, more preferably 10 to 95% by mass, still more preferably 30 to 90% by mass, but not particularly limited thereto.

The shell polymer is not limited to those described above as long as it has a three-dimensional cross-linked structure and can form a shell of the cross-linked hollow particle. For example, the shell polymer may be phenol resin, melamine resin, urea resin, unsaturated polyester resin, epoxy resin, polyurethane resin, silicon resin, alkyd resin, thermally curable modified polyphenylene ether resin, thermally curable polyimide resin, benzoxazine resin, urea resin, allyl resin, aniline resin, maleimide resin, bismaleimide triazine resin, liquid crystalline polyester resin, vinyl ester resin, unsaturated polyester resin, cyanate ester resin, polyether imide resin, or the like.

The cross-linked hollow particle can be suitably produced by the production method comprising (A) a mixed solution preparation step, (B) a suspension step, (C) a polymerization step, and (D) a solvent removal step.

Specifically, cross-linked hollow particle can be suitably produced by the production method comprising:
(A) a mixed solution preparation step of preparing a mixed solution containing polymerizable monomers containing a cross-linkable monomer, a hydrophobic organic solvent, a polymerization initiator, and an aqueous medium;
(B) a suspension step of suspending the mixed solution obtained in the mixed solution preparation step, thereby preparing a suspension in which droplets of the polymerizable monomer composition containing the polymerizable monomers, the hydrophobic organic solvent, and the polymerization initiator are dispersed in the aqueous medium;
(C) a polymerization step of subjecting the suspension obtained in the suspension step to a polymerization reaction, thereby preparing a precursor composition containing precursor particles having hollow portions and the hydrophobic organic solvent encapsulated in the hollow portions; and
(D) a solvent removal step of removing the hydrophobic organic solvent encapsulated in the precursor particles obtained in the polymerization step.

### (A) Mixed Solution Preparation Step

The mixed solution preparation step is a step of preparing a mixed solution containing polymerizable monomers containing a cross-linkable monomer, a hydrophobic organic solvent, a polymerization initiator, and an aqueous medium. The organic cross-linked hollow particle used in the present invention is preferably produced by the production method comprising such a step.

### (Polymerizable Monomer)

The polymerizable monomers to be used are the above-mentioned cross-linkable monomer, and optionally the above-mentioned monofunctional monomer. The monomer composition of the polymerizable monomers can be any monomer composition as long as the monomer composition of the target shell polymer can be obtained. The content of the polymerizable monomers (the total amount of the cross-linkable monomer and the monofunctional monomer) in the mixed solution prepared in the mixed solution preparation step is not particularly limited, but from the viewpoint of the balance between the particle size and the mechanical strength, the content is preferably 15 to 55% by mass, more preferably 25 to 50% by mass relative to 100% by mass of the total mass of the components in the mixed solution excluding the aqueous medium.

### (Hydrophobic Organic Solvent)

As the hydrophobic organic solvent, a non-polymerizable and poorly water-soluble organic solvent is used. The hydrophobic organic solvent acts as a spacer material which forms (a) hollow portion(s) inside the particle. Although the hydrophobic organic solvent is not particularly limited, hydrocarbon solvents can be suitably used. Specific examples thereof include solvents having relatively high volatility, such as saturated hydrocarbon solvents such as butane, pentane, normal hexane, cyclohexane, heptane, and octane; aromatic hydrocarbon solvents such as benzene, toluene, and xylene; carbon disulfide, carbon tetrachloride, and the like. The amount of the hydrophobic organic solvent contained in the mixed solution is preferably 50 to 500 parts by mass, more preferably 60 to 400 parts by mass, still more preferably 80 to 350 parts by mass, particularly preferably 100 to 320 parts by mass relative to 100 parts by mass of the total mass of the polymerizable monomers.

### (Polymerization Initiator)

As the polymerization initiator, use of an oil-soluble polymerization initiator is preferred. By using the oil-soluble polymerization initiator as the polymerization initiator, the polymerization initiator can be suitably taken into droplets of the polymerizable monomer composition in a suspension to be prepared in the suspension step described later. The oil-soluble polymerization initiator is not particularly limited as long as it has a solubility in water of 0.2% by mass or less and is lipophilic. Examples of the oil-soluble polymerization initiator include benzoyl peroxide, lauroyl peroxide, t-butylperoxide 2-ethylhexanoate, t-butyl peroxydiethylacetate, t-butyl peroxypivalate, 2,2′-azobis(2,4-dimethylvaleronitrile), azobisisobutyronitrile, and the like. The amount of the polymerization initiator contained is preferably 0.1 to 15 parts by mass, more preferably 0.5 to 12 parts by mass, still more preferably 1 to 10 parts by mass relative to 100 parts by mass of the total mass of the polymerizable monomers in the mixed solution. By controlling the content of the polymerization initiator within these ranges above, the polymerization reaction is caused to sufficiently progress, it is less likely that the polymerization initiator will remain after the end of the polymerization reaction, and it is less likely that unexpected side reactions will proceed.

### (Aqueous Medium)

Examples of aqueous media include media selected from the group consisting of water, hydrophilic solvents, and mixtures of water and hydrophilic solvents. The hydrophilic solvent is not particularly limited as long as it is sufficiently mixed with water and does not cause phase separation, and examples thereof include alcohols such as methanol and ethanol; tetrahydrofuran (THE); dimethyl sulfoxide (DMSO); and the like. Among these aqueous media, use of water is preferred due to the level of the polarity. When a mixture of water and a hydrophilic solvent is used, to appropriately form droplets of the polymerizable monomer composition containing the polymerizable monomers, the hydrophobic organic solvent, and the polymerization initiator, preferably, the entire mixture does not have an excessively reduced polarity. When a mixture of water and a hydrophilic solvent is used, the mixing ratio (mass ratio) of water to the hydrophilic solvent is preferably 99:1 to 50:50.

In the mixed solution preparation step, a dispersion stabilizer is preferably used in addition of the polymerizable monomers, the hydrophobic organic solvent, the polymerization initiator, and the aqueous medium. In other words, the mixed solution preparation step is preferably a step of preparing a mixed solution containing the polymerizable monomers, the hydrophobic organic solvent, the polymerization initiator, the aqueous medium, and the dispersion stabilizer.

The dispersion stabilizer is a compound which causes droplets of the polymerizable monomer composition to be dispersed in the aqueous medium in the suspension step described later, and may be either an inorganic dispersion stabilizer or an organic dispersion stabilizer.

Examples of inorganic dispersion stabilizers include colloidal silica, magnesium hydroxide, calcium phosphate, calcium carbonate, barium sulfate, calcium oxalate, calcium carbonate, magnesium carbonate, barium carbonate, tricalcium phosphate, aluminum hydroxide, magnesium hydroxide, ferric hydroxide, hydroxy apatite, silicic acid diatomite, clay, bentonite, and the like.

Examples of organic dispersion stabilizers include methylcellulose, hydroxypropylmethylcellulose, carboxymethylcellulose, starch, and the like.

Among these, inorganic dispersion stabilizers are preferred from the viewpoint of a high effect of stabilizing dispersion and ease in control of the particle diameter of droplets of the polymerizable monomer composition containing the polymerizable monomers, the hydrophobic organic solvent, and the polymerization initiator. Among these inorganic dispersion stabilizers, metal-containing dispersion stabilizers are preferred, and poorly water-soluble inorganic metal salts are more preferred. The poorly water-soluble inorganic metal salts are preferably inorganic metal salts having a solubility in 100 g of water of 0.5 g or less, and examples thereof include magnesium hydroxide, calcium hydroxide, barium hydroxide, calcium phosphate, and the like. Among these, magnesium hydroxide is more preferred. These dispersion stabilizers can be used alone or in combination.

To further enhance the effect of stabilizing dispersion, the dispersion stabilizer is preferably used in the form of a dispersion or a solution of the dispersion stabilizer by dispersing or dissolving the dispersion stabilizer in an aqueous medium. In other words, in the mixed solution preparation step, the mixed solution is preferably obtained by mixing the polymerizable monomers, the hydrophobic organic solvent, and the polymerization initiator with the dispersion stabilizer in the form of a dispersion or a solution. The aqueous medium to be used can be those listed above.

For the mixing ratio of the dispersion stabilizer in the form of a dispersion or a solution thereof to the aqueous medium, the mass ratio of “dispersion stabilizer: aqueous medium” is preferably 0.7:100 to 7:100, more preferably 1.0:100 to 4.0:100, still more preferably 1.4:100 to 3:100. When the mixing ratio of the dispersion stabilizer to the aqueous medium falls within these ranges above, the effect of stabilizing dispersion can be more appropriately enhanced.

In the mixed solution preparation step, the mixed solution can be obtained by mixing the above-mentioned components by stirring or the like. At this time, other materials may be optionally added in addition to the above-mentioned components. In the mixed solution preparation step, a mixed solution is prepared, in which an oil phase containing lipophilic materials such as the polymerizable monomers, the hydrophobic organic solvent, and the polymerization initiator is dispersed into a particle size of about several millimeters in an aqueous phase containing the aqueous medium and the dispersion stabilizer optionally used. The dispersion state of these components in the mixed solution can also be observed by the naked eye depending on the types of the components.

In the mixed solution preparation step, to readily obtain a homogenous composition of the shell portion, the mixed solution is preferably prepared by preliminarily preparing an oil phase containing the polymerizable monomers, the hydrophobic organic solvent, and the polymerization initiator, and mixing the oil phase with a dispersion or solution prepared by dispersing or dissolving the dispersion stabilizer in the aqueous medium.

### (B) Suspension Step

The suspension step is a step of suspending the mixed solution obtained in the mixed solution preparation step described above, thereby preparing a suspension in which droplets of the polymerizable monomer composition containing the polymerizable monomers, the hydrophobic organic solvent, and the polymerization initiator are dispersed in the aqueous medium.

The suspension method for forming droplets of the polymerizable monomer composition is not particularly limited. Preferred is a method of stirring the mixed solution obtained in the mixed solution preparation step with a stirrer enabling strong stirring.

In the suspension step, a suspension in which droplets of the polymerizable monomer composition containing the lipophilic materials above are homogeneously dispersed in the aqueous medium can be obtained. Such droplets of the polymerizable monomer composition are difficult to observe with the naked eye, and can be observed with a known observation apparatus such as an optical microscope, for example. In the suspension step, phase separation occurs in the droplets of the polymerizable monomer composition, and thus a hydrophobic organic solvent having a low polarity is likely to concentrate on the insides of the droplets. As a result, in the obtained droplets, the hydrophobic organic solvent is distributed in the inside of each droplet and other materials other than the hydrophobic organic solvent are distributed in the periphery thereof.

### (C) Polymerization Step

The polymerization step is a step of subjecting the suspension prepared in the suspension step described above to a polymerization reaction, thereby preparing a precursor composition containing precursor particles having hollow portions and containing the hydrophobic organic solvent encapsulated in the hollow portions.

In the polymerization step, the polymerizable monomers in the droplets are polymerized in the state where the hydrophobic organic solvent is encapsulated in the droplets of the polymerizable monomer composition. Thereby, precursor particles each having a shell containing a resin as the polymerized product of the polymerizable monomers and a hollow portion filled with the hydrophobic organic solvent are formed.

In the polymerization step, the droplets of the polymerizable monomer composition are subjected to a polymerization reaction in the state where the hydrophobic organic solvent is encapsulated in the droplets. Thereby, the polymerization reaction is likely to progress while the shape of the droplets is maintained, and the size and void ratio of the precursor particles are readily controlled. Since the polymerizable monomers are used in combination with the hydrophobic organic solvent, the hydrophobic organic solvent has a low polarity to the shell of the precursor particles, and thus is less compatible with the shell. Thus, it is likely that phase separation sufficiently occurs and only one hollow portion is formed in the shell.

The polymerization method is not particularly limited, and for example, a batch-wise (batch) method, a semi-continuous method, a continuous method, or the like can be used. The polymerization temperature is preferably 40 to 90 °C, more preferably 50 to 80 °C. The reaction time for polymerization is preferably 1 to 48 hours, more preferably 3 to 24 hours.

Through the polymerization step, a precursor composition is obtained, in which precursor particles encapsulating the hydrophobic solvent are dispersed in an aqueous phase containing the aqueous medium as the main component.

### (D) Solvent Removal Step

The solvent removal step is a step of removing the hydrophobic organic solvent encapsulated in the precursor particles obtained in the polymerization step.

Preferably, prior to solvent removal in the solvent removal step, the precursor composition obtained in the polymerization step is preliminarily subjected to solid liquid separation, thereby obtaining solid contents containing the precursor particles encapsulating the hydrophobic organic solvent by the solid liquid separation. After the solid contents containing the precursor particles are obtained by the solid liquid separation, the hydrophobic organic solvent encapsulated in the precursor particles is removed in the air. Thereby, the hydrophobic organic solvent inside the precursor particles is replaced by air, and cross-linked hollow particles filled with a gas can be obtained.

The method for subjecting the precursor composition to solid liquid separation is not particularly limited, and a known method can be used. Examples of the solid liquid separation method include centrifugation, filtration, static separation, and the like. Among these, centrifugation or filtration can be used. From the viewpoint of ease in operation, centrifugation may be used. After the solid liquid separation is performed, an optional step such as a preparative drying step may be further used. Examples of the preparative drying step include a step of preparatively drying the solid contents obtained after the solid liquid separation step with a drying apparatus such as a dryer or a drying tool such as a hand dryer.

The expression “in the air” in the solvent removal step strictly indicates under an environment in which no liquid content is present on the outsides of the precursor particles and under an environment in which only a trace of liquid content in an amount not affecting the removal of the hydrophobic organic solvent is present on the outsides of the precursor particles. It can also be said that the expression “in the air” is a state where no precursor particles are present in the slurry or a state where the precursor particles are present in the dry powder. In other words, in the solvent removal step, it is desired that the hydrophobic organic solvent is removed under an environment in which the precursor particles are directly in contact with an external gas.

The method of removing the hydrophobic organic solvent in the precursor particles in the air is not particularly limited, and a known method can be used. Examples thereof include drying under reduced pressure, drying with heating, and pneumatic conveying drying. These methods may be used in combination. In particular, when drying with heating is used, the heating temperature needs to be set at a temperature equal to or higher than the boiling point of the hydrophobic organic solvent and equal to or lower than the highest temperature at which the shell structures of the precursor particles do not collapse. Accordingly, although it depends on the composition of the shell in the precursor particles and the type of the hydrophobic organic solvent, the heating temperature is preferably 50 to 200 °C, more preferably 70 to 200 °C, still more preferably 100 to 200 °C. By the drying operation in the air, the hydrophobic organic solvent inside the precursor particles is replaced by an external gas, and as a result, cross-linked hollow particles having hollow portions filled with the gas can be obtained.

The drying atmosphere is not particularly limited, and can be appropriately selected according to the application of the cross-linked hollow particle. The drying atmosphere to be considered is air, oxygen, nitrogen, argon, or the like, for example. By filling the cross-linked hollow particles with a gas once and then drying the cross-linked hollow particles under reduced pressure, cross-linked hollow particles whose insides are temporarily in vacuum are also obtained.

Alternatively, the hydrophobic organic solvent may be removed as follows: the slurry-like precursor composition obtained in the polymerization step is not subjected to the solid liquid separation, and the hydrophobic organic solvent encapsulated in the precursor particles is replaced by the aqueous medium of the slurry in the slurry containing the precursor particles and the aqueous medium.

Besides, as the method of removing the hydrophobic organic solvent encapsulated in the precursor particles, for example, the following methods can be used: A method of removing the hydrophobic organic solvent in the precursor particles in a solution by bubbling; a method of evaporating and distilling off the hydrophobic organic solvent encapsulated in the precursor particles from the precursor composition under a predetermined pressure (under high pressure, under normal pressure, or under reduced pressure); a method of introducing an inert gas, such as nitrogen, argon, or helium, or water vapor into the precursor composition under a predetermined pressure (under high pressure, under normal pressure, or under reduced pressure), and evaporating and distilling off the hydrophobic organic solvent.

### (E) Other Steps

The production method may comprise other steps. Examples of the other steps include (E-1) a washing step, and (E-2) another hollow portion replacement step.

### (E-1) Washing Step

The production method preferably comprises a washing step before or after the recovery step. For example, when the dispersion stabilizer is used, preferably, the production method comprises a washing step before the recovery step, the washing step involving performing washing by adding an acid or an alkali to remove the residual dispersion stabilizer in the cross-linked hollow particle slurry containing the cross-linked hollow particles and the aqueous medium. When the dispersion stabilizer used is a dispersion stabilizer soluble to an acid, preferably, the acid is added to the precursor composition containing the precursor particles, and washing is performed. In contrast, when the dispersion stabilizer used is a dispersion stabilizer soluble to an alkali, preferably, the alkali is added to the precursor composition containing the precursor particles, and washing is performed.

When the dispersion stabilizer soluble to an acid is used as the dispersion stabilizer, it is preferred that the acid be added to the precursor composition containing the precursor particles and the pH be adjusted to preferably 6.5 or less, more preferably 6 or less. As the acid to be added, an inorganic acid, such as sulfuric acid, hydrochloric acid, or nitric acid, and an organic acid, such as formic acid or acetic acid, can be used. In particular, sulfuric acid is suitable because of its high efficiency in removal of the dispersion stabilizer and a light load over the production facility.

### (E-2) Another Hollow Portion Replacement Step

Another hollow portion replacement step is a step of replacing a gas or a liquid inside the cross-linked hollow particles by another gas or liquid. By such a replacement, the environment inside the cross-linked hollow particles can be changed, a molecule can be selectively sealed inside the cross-linked hollow particles, or the chemical structure inside the cross-linked hollow particles can be modified according to the application.

Examples of organic inorganic composite hollow particles include hollow particles having an outer shell formed from a combination of the inorganic material and the organic material listed above. Examples of the method of producing the organic inorganic composite hollow particle include, but are not particularly limited to, appropriate polymerization methods such as emulsion polymerization, dropwise emulsion polymerization, soap-free polymerization, microemulsion polymerization, miniemulsion polymerization, and microsuspension polymerization in which a polymerizable silane coupling agent having a vinyl group, an acrylic group, a methacrylic group, a styryl group, or the like inside the structure and a non-polymerizable organic solvent are used; interface polymerization in which a silane coupling agent having an epoxy group, an isocyanate group, a ureido group, an amino group, a mercapto group, or a halogen group inside the structure is used; and a method of silica coating the surfaces of the organic hollow particles preliminarily prepared, using a silane coupling agent.

The hollow particle has a volume average particle size (Dv) of preferably 1 to 50 μm, more preferably 5 to 45 μm, still more preferably 2 to 40 μm, although it is not particularly limited thereto.

The hollow particle has a particle size distribution (Dv/Dn) (volume average particle size (Dv)/number average particle diameter (Dn)) of preferably 1.02 to 2.00, more preferably 1.04 to 1.60, although it is not particularly limited thereto.

The hollow particle has a true density of preferably 0.95 to 1.4 g/cm³, more preferably 1.0 to 1.3 g/cm³, although it is not particularly limited thereto. The true density of the hollow particle indicates the density of only the shell portion in the hollow particle.

The hollow particle has an apparent density at 20 °C of preferably 0.15 to 0.9 g/cm³, more preferably 0.2 to 0.8 g/cm³, still more preferably 0.25 to 0.7 g/cm³, particularly preferably 0.25 to 0.6 g/cm³, most preferably 0.25 to 0.5 g/cm³, although it is not particularly limited thereto. When the hollow particle has an apparent density within the above ranges, the effect caused by addition of the hollow particle can be more effectively demonstrated in the 3D-printer modeling material according to the present invention.

The apparent density of the hollow particle indicates the density of the entire hollow particle including the shell portion of the hollow particle and the hollow portion thereof. For example, when the hollow particle is a cross-linked hollow particle, the apparent density can be controlled by adjusting the monomer composition of the shell polymer, or the types and amounts of the dispersion stabilizer and the hydrophobic organic solvent used in production of the hollow particle by a suspension polymerization method and the conditions for suspension.

The apparent density D of the hollow particle is measured by the following method. Initially, about 30 cm³ of the hollow particle is charged into a volumetric flask having a volume of 100 cm³, and the mass of the hollow particle charged is precisely weighed. Next, isopropanol is added exactly up to the gauge line of the volumetric flask containing the hollow particle with care to avoid inclusion of air bubbles. The mass of isopropanol added to the volumetric flask is precisely weighed, and the apparent density D₁(g/cm³) of the hollow particle is calculated based on the following Expression (II):

apparent density D₁(g/cm³) of hollow particle=[mass of hollow particle]÷(100−[mass of isopropanol]÷[density of isopropanol at measurement temperature) (II)

The amount of the hollow particle contained is preferably 1 to 50 parts by mass, more preferably 2 to 40 parts by mass, still more preferably 3 to 30 parts by mass, particularly preferably 5 to 25 parts by mass relative to 100 parts by mass of the total amount of the matrix polymer and the hollow particle contained, although not particularly limited thereto. To obtain a lighter modeled body, the amount of the hollow particle contained may be 10 parts by mass or more, 15 parts by mass or more, 20 parts by mass or more relative to 100 parts by mass of the total amount of the matrix polymers and the hollow particle. On the other hand, to produce a modeled body having higher flexibility and higher mechanical strength with higher modeling efficiency, the amount of the hollow particle contained may be 20 parts by mass or less, 15 parts by mass or less, 12 parts by mass or less relative to 100 parts by mass of the total amount of the matrix polymer and the hollow particle contained.

### [Other Compounding Materials]

The 3D-printer modeling material according to the present invention may contain other compounding materials other than the matrix polymer and the hollow particle as long as the object of the present invention is not impaired.

As other compounding materials, the 3D-printer modeling material according to the present invention can contain additives such as fillers including organic fillers and inorganic fillers, colorants including dyes and pigments, an antistatic agent, a terminal capping agent, an ultraviolet absorbing agent, an ultraviolet light preventer, a heat stabilizer, a photostabilizer, an anti-fogging agent, an anti-mist agent, a plasticizer, a flame retardant, a coloring preventer, a die drool preventer, an antioxidant, a mold release agent (erucamide, stearamide, oleamide, ethylenebisstearamide, ethylenebisoleamide, ethylenebislauramide), a moist preventer, an oxygen barrier agent, a nucleator, a compatibilizer, a cross-linking agent, and a cross-linking aid. These compounding materials may be used alone or in combination.

Examples of organic fillers include fibrous organic fillers such as aramid fibers, polyimide fibers, polybenzothiazole fibers, and polyethylene fibers; plant-derived fibers such as nanocellulose, hemp, and bamboo; and the like.

Examples of inorganic fillers include boron fibers, glass beads, glass fibers, flat cross-sectional glass fibers, glass milled fibers, ceramic beads, wollastonite, mica, synthetic mica, sericite, talc, clay, zeolite, bentonite, kaolinite, dolomite, silica, zeolite, feldspar powder, potassium titanate, fine powdery silicic acid, calcium carbonate, magnesium carbonate, barium sulfate, aluminum oxide, magnesium oxide, calcium oxide, titanium oxide, silicon oxide, aluminum silicate, zirconium silicate, gypsum, novaculite, dawsonite, montmorillonite, calcium sulfide, zinc oxide, boron nitride, glass flakes, metal flakes, metal fibers, basalt fibers, rock wool, ceramic fibers, slag potassium titanate, boron whisker, aluminum borate, xonotlite, palygorskite (attapulgite), sepiolite, and the like. Examples of inorganic fillers also include carbon-based fillers, such as carbon fibers such as carbon fibers, carbon milled fibers, and carbon nanotubes; carbon black; graphite; and carbon flakes. Moreover, inorganic fillers having surfaces treated with a coupling agent to enhance the bonding strength to the matrix polymer can be used. Examples of the coupling agent include silane coupling agents, aluminum coupling agents, titanium coupling agents, and the like.

These organic fillers and inorganic fillers are preferably not in the form of a hollow particle. Specifically, these are preferably fibrous, particulate, or platy.

The amount of the other compounding materials contained in the 3D-printer modeling material is not particularly limited as long as the object of the present invention is not impaired. The amount is preferably 0 to 5 parts by mass, more preferably 0 to 1 part by mass relative to 100 parts by mass of the total amount of the matrix polymer and the hollow particle contained. The 3D-printer modeling material according to the present invention may be composed of substantially only the matrix polymer and the hollow particle.

### [Properties of 3D-Printer Modeling Material]

The 3D-printer modeling material according to the present invention comprises the matrix polymer and the hollow particle described above, wherein the D-printer modeling material has an apparent density at 20 °C of 0.9 g/cm³ or less, and the 3D-printer modeling material shows a shore A hardness of 61 to 98 at a time point of 15 seconds from the start of indentation, the shore A hardness being determined in accordance with JIS K 6253-3:2012.

The 3D-printer modeling material according to the present invention has an apparent density at 20 °C of 0.9 g/cm³ or less. Since the 3D-printer modeling material according to the present invention has such a low apparent density, it allows production of a lightweight modeled body.

Although the apparent density at 20 °C of the 3D-printer modeling material according to the present invention is not particularly limited as long as it is 0.9 g/cm³ or less, to produce a lighter modeled body having high mechanical strength in addition to high flexibility with high modeling efficiency, it is preferably 0.6 to 0.9 g/cm³, more preferably 0.65 to 0.86 g/cm³, still more preferably 0.7 to 0.83 g/cm³. The apparent density at 20 °C of the 3D-printer modeling material can be measured by an underwater replacement method in accordance with JIS K 7112.

The apparent density at 20 °C of the 3D-printer modeling material according to the present invention is preferably 0.5 to 0.99 times, more preferably 0.6 to 0.95 times, still more preferably 0.7 to 0.9 times the density at 20 °C of the matrix polymer contained in the 3D-printer modeling material according to the present invention.

When the 3D-printer modeling material according to the present invention is measured for shore A hardness in accordance with JIS K 6253-3:2012, the shore A hardness at a time point of 15 seconds from the start of indentation is 61 to 98. Hereinafter, the shore A hardness may be referred to as “shore A hardness of the 3D-printer modeling material” in some cases.

It is sufficient that the shore A hardness of the 3D-printer modeling material according to the present invention is 61 to 98, and the shore A hardness is not particularly limited. It is preferably 64 to 95, more preferably 67 to 90. When the shore A hardness of the 3D-printer modeling material falls within the above ranges, the modeling efficiency can be further enhanced, and a modeled body having mechanical strength and flexibility in a better balance can be obtained.

If the shape or the like of the 3D-printer modeling material is not suitable for measurement of the shore A hardness, the shore A hardness of a test piece (modeled body) formed from the 3D-printer modeling material is measured, and the measured value can be defined as the shore A hardness of the 3D-printer modeling material. Specifically, the shore A hardness of the 3D-printer modeling material can be determined by the method described in Examples.

Preferably, in the 3D-printer modeling material according to the present invention, the recovery rate of the shore A hardness determined under the following conditions is 0.01 to 0.4/sec. Specifically, a modeled body formed from the 3D-printer modeling material by performing 3D-printer modeling by fused deposition modeling at a modeling temperature of 240 °C is measured for shore A hardness in accordance with JIS K 6253-3:2012, and the difference between the shore A hardness immediately after indentation and the shore A hardness at a time point of 15 seconds from the start of indentation is divided by 15 seconds to determine the recovery rate of the shore A hardness. The resulting recovery rate is preferably 0.01 to 0.4/sec. Hereinafter, the recovery rate of the shore A hardness may be referred to as “recovery rate of the shore A hardness of the 3D-printer modeling material” in some cases.

The recovery rate of the shore A hardness of the 3D-printer modeling material is preferably 0.01 to 0.4/sec, more preferably 0.05 to 0.38/sec, still more preferably 0.1 to 0.36/sec. When the recovery rate of the shore A hardness of the 3D-printer modeling material falls within the above ranges, the modeling efficiency can be further enhanced, and a modeled body having mechanical strength and flexibility in a better balance can be obtained.

Examples of a method of controlling the shore A hardness of the 3D-printer modeling material and the recovery rate of the shore A hardness within suitable ranges include a method in which the matrix polymer and the hollow particle used are selected from the suitable ones described above, and the contents thereof are selected to the suitable amounts described above.

Preferably, the 3D-printer modeling material according to the present invention is molded into a form which can be used in a 3D-printer. Examples of the form which can be used in the 3D-printer include pellet shapes, filament shapes, and the like. Among these, the 3D-printer modeling material according to the present invention is preferably in a filament shape, which can be used in a general-purpose 3D-printer of fused deposition modeling.

### [Method of Producing 3D-Printer Modeling Material]

The 3D-printer modeling material is prepared by mixing the matrix polymer and the hollow particle with compounding agents used as needed. Specifically, examples of the production method thereof include a method of adding the hollow particle and compounding agents optionally used to the melted matrix polymer, and mixing these by melt kneading. In this case, all the components may be each independently fed to a melt kneader. Alternatively, part of the components may be preparatively mixed, and then the components preparatively mixed and the remainder of the components may be independently fed to the melt kneader.

The matrix polymer, the hollow particle, and the compounding agents optionally used can be kneaded using a kneader, a roll mill, a Brabender, a single screw extruder, a twin screw extruder, a multi screw extruder, or the like, for example. Extrusion modeling is preferred because a filament-shaped 3D-printer modeling material and a pellet-shaped 3D-printer modeling material which can be used in a general-purpose 3D-printer can be produced with high production efficiency. Melt kneading is performed preferably using a twin screw extruder because a more homogeneous 3D-printer modeling material is obtained. When melt kneading is performed using an extruder, the cylinder temperature is preferably 150 to 220 °C, more preferably 170 to 210 °C, and the die temperature is preferably 160 to 220 °C, more preferably 180 to 210 °C.

When the 3D-printer modeling material is produced using an extruder such as a twin screw extruder as described above, the material after the kneading is extruded from the extruder and is continuously formed into a pellet form or a filament form. Thereby, a pellet- or filament-shaped 3D-printer modeling material can be produced with high production efficiency. In this case, suitable cylinder temperature and die temperature are as described above.

The pellet-shaped 3D-printer modeling material can be obtained by extruding the material after kneading, and directly cutting the material into pellets, for example. Alternatively, the pellet-shaped 3D-printer modeling material can also be obtained by extruding the material after kneading into a strand, followed by cooling and cutting.

The filament-shaped 3D-printer modeling material may be a monofilament or a multi-filament. Preferred is a monofilament. The filament-shaped 3D-printer modeling material may be unstretched, or may be stretched. Although the diameter of the filament-shaped 3D-printer modeling material can be freely adjusted to be suitable for the 3D-printer to be used, generally, the diameter is preferably 1.5 to 3.2 mm, more preferably 1.6 to 3.1 mm.

The filament-shaped 3D-printer modeling material can be produced by a method of extruding the material after kneading, and solidifying the material by cooling, for example. Solidification by cooling is performed in a solution bath usually at 0 to 100 °C, preferably at 20 to 80 °C.

The filament-shaped 3D-printer modeling material may be produced by extrusion modeling the material after kneading into a filament shape, and stretching the extrusion modeled product before or after solidification by cooling. Examples of a stretching method include, but should not be limited to, a method of performing stretching with a stretch ratio of 2 to 5 times while performing a heat treatment at a 170 to 250 °C, and repeating such stretching as needed. After the stretching, preferably, a relax heat treatment (stretch ratio: 0.9 to 0.99 times) is performed while a heat treatment is being performed at 130 to 200 °C.

The filament-shaped 3D-printer modeling material thus obtained is usually wound around a bobbin or the like, which is accommodated in a cartridge or the like.

### <Modeled Body>

The 3D-printer modeling material according to the present invention is used in 3D-printer modeling by fused deposition modeling, and a modeled body can be formed by performing 3D-printer modeling by fused deposition modeling using the 3D-printer modeling material according to the present invention. The present invention also relates to a modeled body formed from the 3D-printer modeling material according to the present invention.

Since the modeled body according to the present invention is obtained using the 3D-printer modeling material according to the present invention, the modeled body is lightweight and has high flexibility, has the surface whose rough skin (roughened surface of the modeled body) is suppressed, and has a good appearance. Further, the modeled body according to the present invention also has sufficient mechanical strength and elasticity.

The modeled body according to the present invention has an apparent density at 20 °C of usually 0.9 g/cm³ or less, preferably 0.6 to 0.9 g/cm³, more preferably 0.65 to 0.86 g/cm³, still more preferably 0.7 to 0.83 g/cm³. The apparent density at 20 °C of the modeled body can be measured by an underwater replacement method in accordance with JIS K 7112.

The apparent density at 20 °C of the modeled body according to the present invention is preferably 0.5 to 0.99 times, more preferably 0.6 to 0.95 times, still more preferably 0.7 to 0.9 times the density at 20 °C of the matrix polymer contained in the modeled body according to the present invention.

When the modeled body according to the present invention is measured for shore A hardness in accordance with JIS K 6253-3:2012, the shore A hardness at a time point of 15 seconds from the start of indentation (shore A hardness measured in accordance with JIS K 6253-3:2012) is usually 61 to 98, more preferably 64 to 95, still more preferably 67 to 90.

When the modeled body according to the present invention is measured for shore A hardness in accordance with JIS K 6253-3:2012, the recovery rate of the shore A hardness is preferably 0.01 to 0.4/sec, more preferably 0.05 to 0.38/sec, still more preferably 0.1 to 0.36/sec, the recovery rate of the shore A hardness being determined by dividing the difference between the shore A hardness immediately after the start of indentation and the shore A hardness at a time point of 15 seconds from the start of indentation by 15 seconds.

### [Method of Modeling Modeled Body]

The modeled body according to the present invention can be formed by performing 3D-printer modeling by fused deposition modeling using the 3D-printer modeling material according to the present invention. Hereinafter, a 3D-printer modeling method by fused deposition modeling will be described.

Initially, the 3D-printer modeling material is fed to a 3D-printer. When a filament (filament-shaped 3D-printer modeling material) is used, usually, the filament is engaged with a drive roll such as a nip roll or a gear roll, and is fed to the extrusion head while the filament is being pulled out.

The 3D-printer modeling material fed to the 3D-printer is melted by heating in the extrusion head, and is extruded from the distal end nozzle. The temperature of the extrusion head is preferably 150 to 250 °C, more preferably 200 to 240 °C. The temperature of the 3D-printer modeling material ejected from the extrusion head is preferably 150 to 250 °C, more preferably 200 to 240 °C. The base temperature is preferably 80 °C or lower. When the temperature of the 3D-printer modeling material ejected from the extrusion head falls within the above ranges, a lightweight modeled body can be modeled with high productivity and higher modeling efficiency. When the temperature falls within the above ranges, occurrence of defects such as thermal decomposition or burning of the resin, yellowing, smoking, an odor, stickiness, and a bad appearance is easily prevented.

The 3D-printer modeling material is ejected from the extrusion head in the form of a strand having a diameter of preferably 0.01 to 1.0 mm, more preferably 0.02 to 0.5 mm. The 3D-printer modeling material ejected in such a form is preferred because the reproductivity of a print model tends to be further improved. To enhance the solvent resistance and heat resistance of the resulting modeled body, the modeled body can also be cross-linked by irradiation with a radiation ray or an electron beam.

The 3D-printer modeling material and the modeled body according to the present invention are used in 3D-printer modeling by fused deposition modeling having great freedom in design, and therefore, it is applicable in extremely broad applications. In particular, the 3D-printer modeling material according to the present invention allows production a lightweight modeled body having high flexibility with high modeling efficiency. Thus, the 3D-printer modeling material according to the present invention can be suitably used in applications where a weight reduction is required and those where flexibility is required.

Examples of applications of the 3D-printer modeling material according to the present invention include, but are not particularly limited to, parts of mobile bodies such as airplanes, automobiles, trains, motorcycles, boats, bicycle, drones, satellites, and shuttles (such as space shuttles); parts of daily goods such as stationery, brushes, rings, jewelry goods, watches, cooking tools, kitchen goods, cleaning tools, home appliances, and toys; parts of things to wear, such as shoes, clothes, fasteners, buttons, snaps, gloves, leg guards, hats and caps, knee pads, elbow pads, helmets, and head gears; parts of devices to wear, such as prostheses, assist suits, and wearable devices; parts of sport goods such as rackets and grips; a variety of materials such as agricultural materials, gardening materials, fishing materials, and civil engineering and construction materials; electrical and electronic parts such as electronic circuit substrates and casings; industrial parts such as gears, motors, tools, propellers, impellers, wheels, housings for machines and apparatuses, gaskets, O-rings, pipes, connectors, and reflectors; medical parts for medical devices, stents, catheters, braces, and artificial organs; containers such as food product containers, mobile phone covers, and bottles; reduced-scale models of cars, houses, and buildings; thermal insulation materials; soundproof materials; damping materials; buffer materials; and the like.

Among these, constituent components of aerial systems such as drones often have complex three-dimensional geometries, and are often modeled by a 3D-printer. Here, in such constituent components of the aerial systems, a weight reduction is required from the viewpoint of improving the drive time of the aerial systems, and high flexibility is also required from the viewpoint of impact absorption properties durability to breakage during dropping or collision. For this reason, the 3D-printer modeling material and the modeled body according to the present invention can be suitably used in applications to constituent components of aerial systems. More specifically, the 3D-printer modeling material according to the present invention can be suitably used in applications to constituent components such as bodies of aerial systems, propellers, arms, and feet, and applications to constituent components for protecting or supporting parts included in aerial systems (e.g., motors, batteries, cameras, propellers, antennas, and the like), such as covers, guard parts, reinforcing parts, supporting tools, and anti-vibration members.

### EXAMPLES

Hereinafter, the present invention will be more specifically described by way of Examples and Comparative Examples, but the present invention is not limited to only these Examples. To be noted, parts and % are mass-based unless otherwise specified. A variety of measurements were performed by the methods described below.

### <Apparent Density of Hollow Particle>

About 30 cm³ of a sample was added to a volumetric flask having a volume of 100 cm³, and the mass of the sample added was precisely weighed. Next, isopropanol was added exactly up to the gauge line of the volumetric flask containing the sample with care to avoid inclusion of air bubbles. The mass of isopropanol added to the volumetric flask was precisely weighed, and the apparent density D₁ (g/cm³) of the sample was calculated based on Expression (II) below.

apparent density D₁(g/cm³) of sample=[mass of sample]÷(100−[mass of isopropanol]÷[density of isopropanol at measurement temperature]) (II)

<Apparent Density of Filament and that of Modeled Body>

The apparent density of a filament and that of a modeled body were measured by an underwater replacement method in accordance with JIS K 7112.

### <Shore A Hardness of Filament and Recovery Rate of Shore A Hardness>

Under conditions for preparing a test piece, 3D-printer modeling by fused deposition modeling was performed on filaments obtained in Examples and Comparative Examples, thereby preparing test pieces. For the resulting test pieces, the shore A hardness was measured in accordance with JIS K 6253-3:2012, and the shore A hardness at a time point of 15 seconds from the start of indentation was determined. The difference between the shore A hardness immediately after the start of indentation and the shore A hardness at a time point of 15 seconds from the start of indentation was divided by 15 seconds to determine the recovery rate of the shore A hardness.

### (Conditions for Preparing Test Piece)

3D-printer: 3D-printer for fused deposition modeling (trade name “FLASHFORGE CreatorPro2”, available from APPLE TREE CO., LTD.)
modeling temperature (nozzle temperature): 240 °C.
process rate (head rate): 10 mm/s
setting value of height of lamination (printing pitch): 0 mm
model for modeling: model for a sample for a bending test (80 mm×10 mm×4 mm in height)

### <Modeling Efficiency>

Using filaments in Examples and Comparative Examples, modeling efficiency during 3D-printer modeling (nozzle clogging and the appearance of the modeled body) were evaluated according to the following criteria.

### [Nozzle Clogging]

The filament was evaluated as “None” of nozzle clogging when die drool (aggregates near the ejection port) never occurred and no nozzle clogging was observed during modeling of one modeled body. In contrast, the filament was evaluated as “Clogged” for nozzle clogging when die drool occurred and nozzle clogging was observed.

### [Appearance of Modeled Body]

For the resulting modeled bodies, the appearance was visually observed. The modeled body was evaluated as “Good” when the modeled body had a smooth surface and no rough skin was observed, and was evaluated as “Bad” when the modeled body had a surface with depressions and projections and rough skin was observed.

### <Maximum-Point Flexural Strain (Flexibility)>

Each of the modeled bodies was subjected to a bending test in accordance with JIS K7171 at a test speed of 2 mm/min and a span between specimen supports of 64 mm, and the maximum-point flexural strain (flexural strain corresponding to the maximum flexural stress) was determined. It can be determined that a larger maximum-point flexural strain indicates that the modeled body has higher flexibility.

### <Maximum-Point Stress (Elasticity)>

Each of the modeled bodies was subjected to a bending test in accordance with JIS K7171 at a test speed of 2 mm/min and a span between specimen supports of 64 mm, the maximum-point stress (maximum flexural stress) was determined. It can be determined that a larger maximum-point stress indicates that the modeled body has higher elasticity.

### Production Example (Production Example of Cross-Linked Hollow Particle)

### (1) Mixed Solution Preparation Step

Initially, the materials below were mixed to prepare an oil phase.
ethylene glycol dimethacrylate (bifunctional heteroatom-containing cross-linkable monomer) 3.97 parts
pentaerythritol tetraacrylate (tetrafunctional heteroatom-containing cross-linkable monomer) 9.5 parts
divinylbenzene (bifunctional cross-linkable hydrocarbon monomer) 4.37 parts
ethylvinylbenzene (monofunctional hydrocarbon monomer) 0.182 parts
2,2′-azobis(2,4-dimethylvaleronitrile) (oil-soluble polymerization initiator) 1.24 parts
hexane 54.5 parts

Next, in a stirring tank, under stirring, an aqueous solution of 16.5 parts of sodium hydroxide (alkali metal hydroxide) dissolved in 55 parts of deionized water was gradually added to an aqueous solution of 23.5 parts of magnesium chloride (water-soluble polyvalent metal salt) dissolved in 225 parts of deionized water to prepare a magnesium hydroxide colloid (poorly water-soluble metal hydroxides colloid) dispersion. Thus, an aqueous phase was obtained. The resulting aqueous phase was mixed with an oil phase to prepare a mixed solution.

### (2) Suspension Step

In the next step, using the mixed solution obtained in the mixed solution preparation step described above, the mixed solution was suspended by stirring at a rotational speed of 4,000 rpm for one minute using a dispersing machine (available from PRIMIX Corporation, product name: Homomixer), thereby preparing a suspension in which monomer droplets encapsulating the hydrophobic organic solvent were dispersed in water.

### (3) Polymerization Step

The suspension obtained in the suspension step above was heated to 65 °C in a nitrogen atmosphere, and was stirred under a temperature condition at 65 °C for 24 hours to cause a polymerization reaction. By this polymerization reaction, a precursor composition was obtained, which was a slurry solution in which precursor particles encapsulating the hydrophobic organic solvent were dispersed in water.

### (4) Washing Step and Solid Liquid Separation Step

The precursor composition obtained in the polymerization step above was washed with diluted sulfuric acid (25 °C, 10 minutes) to adjust the pH to 5.5 or less. In the next step, after water was separated by filtration, 200 parts of deionized water was newly added to prepare a slurry again. Then, a treatment of washing with water (washing, filtration, and dehydration) was repeatedly performed at room temperature (25 °C) several times, followed by separation through filtration to obtain solid contents.

### (5) Drying Step

The precursor particles obtained in the solid liquid separation step above were subjected to a heat treatment for 24 hours with a vacuum dryer under a vacuum condition at 200 °C to remove the water content and the encapsulated solvent. Thus, a cross-linked hollow particle 1 was obtained. The monomer composition of the shell polymer in the resulting cross-linked hollow particle 1 mostly corresponded to the composition of the polymerizable monomers subjected to the polymerization. The resulting cross-linked hollow particle 1 had an apparent density of 0.33 g/cm³.

### [Matrix Polymer]

The matrix polymers used in Examples and Comparative Examples are shown below.
polymer A: polymer containing 33% by mass of a polylactic acid resin (melting point: 170 °C) and 67% by mass of a thermoplastic elastomer (elastomer which has a weight average molecular weight of 100,000 or more and 200,000 or less, and contains a block copolymer including a polystyrene block and a conjugated diene polymer block and a mineral oil-based plasticizer in a mass ratio of the block copolymer to the mineral oil-based plasticizer of 25/75 to 30/70, melting point: 100 °C to 170 °C)), density: 0.95 g/cm³, melting point: 100 to 170 °C.
PLA: polylactic acid resin, density: 1.25 g/cm³

### Example 1-1

The polymer A was used as the matrix polymer, and the cross-linked hollow particle 1 obtained in Production Example 1 was used as the hollow particle. The matrix polymer and the hollow particle were fed to a twin-screw kneading extruder in a proportion of 10 parts of the hollow particle to 90 parts of the matrix polymer. These were subjected to twin-screw kneading extrusion at a temperature for twin-screw kneading of 200 °C and a temperature for extrusion modeling of 200 °C, thereby obtaining a filament (3D-printer modeling material). The resulting filament was evaluated for apparent density, shore A hardness, and recovery rate of the shore A hardness. The results are shown in Table 1.

Using the resulting filament, 3D-printer modeling was performed under the modeling conditions below, obtaining a modeled body. Then, the modeled body was measured and evaluated for modeling efficiency, apparent density, shore A hardness, recovery rate of the shore A hardness, maximum-point flexural strain, and maximum-point stress according to the methods described above. The results are shown in Table 1.

### (Modeling Conditions)

3D-printer: 3D-printer for fused deposition modeling (trade name “FLASHFORGE CreatorPro2”, available from APPLE TREE CO., LTD.)
modeling temperature (nozzle temperature): 220 °C
process rate (head rate): 10 mm/s
setting value of height of lamination (printing pitch): 0 mm
model for modeling: model for a sample for a bending test (80 mm×10 mm×4 mm in height)

### Examples 1-2 and 1-3

Modeled bodies were obtained in the same manner as in Example 1-1 except that the filament obtained in Example 1-1 was used and the modeling temperature was varied as shown in Table 1. The resulting modeled bodies were evaluated as in Example 1-1. The results are shown in Table 1.

### Example 2

A filament (3D-printer modeling material) was obtained in the same manner as in Example 1-1 except that the compounding ratio of the matrix polymer and the hollow particle was varied as shown in Table 1. A modeled body was obtained in the same manner as in Example 1-1 except that the resulting filament was used and the modeling temperature was varied as shown in Table 1, and was evaluated as in Example 1-1. The results are shown in Table 1.

### Example 3

A composition containing 50% by mass of the polymer A and 50% by mass of the PLA was used as the matrix polymer, and the cross-linked hollow particle 1 obtained in Production Example 1 was used as the hollow particle. The matrix polymer and the hollow particle were fed to a twin-screw kneading extruder in a proportion of 20 parts of the hollow particle to 80 parts of the matrix polymer (40 parts of the polymer A and 40 parts of the PLA). Then, these were subjected to twin-screw kneading extrusion at a temperature for twin-screw kneading of 200 °C and a temperature for extrusion modeling of 200 °C, thereby obtaining a filament (3D-printer modeling material). A modeled body was obtained in the same manner as in Example 1-1 except that the resulting filament was used and the modeling temperature was varied as shown in Table 1, and was evaluated as in Example 1-1. The results are shown in Table 1.

### Example 4

A composition containing 70% by mass of the polymer A and 30% by mass of the PLA was used as the matrix polymer, and the cross-linked hollow particle 1 obtained in Production Example 1 was used as the hollow particle. The matrix polymer and the hollow particle were fed to a twin-screw kneading extruder in a proportion of 20 parts of the hollow particle to 80 parts of the matrix polymer (56 parts of the polymer A and 24 parts of the PLA). Then, these were subjected to twin-screw kneading extrusion at a temperature for twin-screw kneading of 200 °C and a temperature for extrusion modeling of 200 °C, thereby obtaining a filament (3D-printer modeling material). A modeled body was obtained in the same manner as in Example 1-1 except that the resulting filament was used and the modeling temperature was varied as shown in Table 1, and was evaluated as in Example 1-1. The results are shown in Table 1.

### Comparative Example 1

The polymer A as the matrix polymer was fed to a twin-screw kneading extruder. Then, the matrix polymer was subjected to twin-screw kneading extrusion at a temperature for twin-screw kneading of 200 °C and a temperature for extrusion modeling of 200 °C, thereby obtaining a filament (3D-printer modeling material). A modeled body was obtained in the same manner as in Example 1-1 except that the resulting filament was used, and was evaluated as in Example 1-1. The results are shown in Table 1.

### Comparative Example 2

The PLA as the matrix polymer was fed to a twin-screw kneading extruder. Then, the matrix polymer was subjected to twin-screw kneading extrusion at a temperature for twin-screw kneading of 200 °C and a temperature for extrusion modeling of 200 °C, thereby obtaining a filament (3D-printer modeling material). A modeled body was obtained in the same manner as in Example 1-1 except that the resulting filament was used and the modeling temperature was varied as shown in Table 1, and was evaluated as in Example 1-1. The results are shown in Table 1. When the shore A hardness of the modeled body in Comparative Example 2 was measured, a shore A hardness of 100 (upper limit value of the shore A hardness) continued for 15 seconds or longer from the start of indentation, which made it impossible to determine the recovery rate of the shore A hardness.

### Comparative Example 3

A filament (3D-printer modeling material) was obtained in the same manner as in Example 1-1 except that the PLA was used as the matrix polymer. Then, a modeled body was obtained in the same manner as in Example 1-1 except that the resulting filament was used and the modeling temperature was varied as shown in Table 1, and was evaluated as in Example 1-1. The results are shown in Table 1. When the shore A hardness of the modeled body in Comparative Example 3 was measured, a shore A hardness of 100 (upper limit value of the shore A hardness) continued for 15 seconds or longer from the start of indentation, which made it impossible to determine the recovery rate of the shore A hardness.

TABLE 1

| | | Ex. 1-1 | Ex. 1-2 | Ex. 1-3 | Ex. 2 | Ex. 3 | Ex. 4 | Comp. Ex. 1 | Comp. Ex. 2 | Canp. Ex. 3 |
|---|---|---|---|---|---|---|---|---|---|---|
| Matrix | Type | Polymer A | | | Polymer | Polymer | Polymer | Poymer | PLA | PLA |
| polymer | | | | | A | A/PLA | A/PLA | A | | |
| | | | | | | (50/50) | (70/30) | | | |
| | Density (g/cm³) | 0.95 | | | 0.95 | 1.1 | 1.04 | 0.95 | 1.26 | 1.05 |
| | Compounding ratio | 90 | | | 85 | 80 | 80 | 100 | 100 | 90 |
| | (wt %) | | | | | | | | | |
| Hollow | Type | Class-inked | | | Cross- | Cross- | Cross- | None | None | Cross- |
| particle | | hollow | | | inked | inked | inked | | | inked |
| | | particle 1 | | | hollow | hollow | hollow | | | hollow |
| | | | | | particle 1 | particle 1 | particle 1 | | | particle 1 |
| | Apparent density | 0.33 | | | 0.33 | 0.33 | 0.33 | — | — | 0.33 |
| | (g/cm³) | | | | | | | | | |
| | Compounding ratio | 10 | | | 10 | 20 | 20 | — | — | 10 |
| | (wt %) | | | | | | | | | |
| Kneading temperature (°C) | | 200 | | | 200 | 200 | 200 | 200 | 200 | 200 |
| Evaluation | Apparent density | 0.30 | | | 0.74 | 0.80 | 0.80 | 0.96 | 1.26 | 0.95 |
| of | (g/cm³) | | | | | | | | | |
| filament | Shore A hardness after | 71 | | | 75 | 78 | 80 | 60 | 100 | 100 |
| | 15 seconds from start | | | | | | | | | |
| | of indentation | | | | | | | | | |
| | Recovery rate (sec) of | 0.07 | | | 0.33 | 0.13 | 0.2 | — | — | — |
| | shore A hardness | | | | | | | | | |
| Modeling temperature (°C) | | 230 | 230 | 240 | 240 | 240 | 240 | 220 | 210 | 210 |
| Evaluation | Nozzles clogging | None | None | None | None | None | None | Clogged | None | None |
| modeling | Appearance of modeled | Good | Good | Good | Good | Good | Good | Bad | Good | Good |
| properties | body | | | | | | | | | |
| Evaluation | Apparent density | 0.30 | 0.60 | 0.73 | 0.74 | 0.30 | 0.30 | 0.95 | 1.25 | 0.96 |
| of | (g/cm³) | | | | | | | | | |
| modeled | Shore A hardness after | 70 | 72 | 71 | 75 | 78 | 80 | 80 | 100 | 100 |
| body | 15 seconds from start | | | | | | | | | |
| | of indentation | | | | | | | | | |
| | Recovery rate (sec) of | 0.2 | 0.13 | 0.07 | 0.33 | 0.13 | 0.2 | 0.2 | — | — |
| | shore A hardness | | | | | | | | | |
| | Maximum-point flexural | 9.4 | 9.3 | 9.4 | 9.4 | 8.9 | 8.9 | 9.8 | 4.1 | 2.5 |
| | strain (%) | | | | | | | | | |
| | Maximum-point stress | 2 | 1.9 | 2 | 2.5 | 2.7 | 2.3 | 1.1 | 7.6 | 7.4 |
| | (MPa) | | | | | | | | | |

Table 1 reveals that the 3D-printer modeling materials each comprising a matrix polymer and a hollow particle, having an apparent density at 20 °C of 0.9 g/cm³ or less, and having a shore A hardness measured under predetermined conditions of 61 to 98 allowed production of lightweight modeled bodies having high flexibility with high modeling efficiency (Examples 1-1, 1-2, 1-3, 2, 3, and 4).

In contrast, in the 3D-printer modeling material not containing the hollow particle, having an extremely large apparent density, and having an extremely small shore A hardness measured under predetermined conditions, the modeling efficiency was inferior, and the resulting modeled body had an extremely large apparent density (Comparative Example 1).

In the 3D-printer modeling material not containing the hollow particle, having an extremely large apparent density, and having an extremely large shore A hardness measured under predetermined conditions, the resulting modeled body had an extremely large apparent density, and had poor flexibility (Comparative Example 2).

In the 3D-printer modeling material having an extremely large apparent density and having an extremely large shore A hardness measured under predetermined conditions, the resulting modeled body had an extremely large apparent density and had poor flexibility (Comparative Example 3).

1. A 3D-printer modeling material used in 3D-printer modeling by fused deposition modeling,
wherein the 3D-printer modeling material comprises a matrix polymer and a hollow particle,
the 3D-printer modeling material has an apparent density at 20 °C of 0.9 g/cm³ or less, and
the 3D-printer modeling material shows a shore A hardness of 61 to 98 at a time point of 15 seconds from the start of indentation, the shore A hardness being determined in accordance with JIS K 6253-3:2012.

2. The 3D-printer modeling material according to claim 1, wherein the 3D-printer modeling material is filament-shaped.

3. The 3D-printer modeling material according to claim 1, wherein the 3D-printer modeling material contains a thermoplastic elastomer as the matrix polymer.

4. The 3D-printer modeling material according to claim 1, wherein the 3D-printer modeling material contains a thermoplastic plastomer and a thermoplastic elastomer as the matrix polymer.

5. The 3D-printer modeling material according to claim 1, wherein the 3D-printer modeling material contains a cross-linked hollow particle as the hollow particle.

6. The 3D-printer modeling material according to claim 1, wherein the matrix polymer has a density at 20 °C of 0.91 to 1.3 g/cm³.

7. The 3D-printer modeling material according to claim 1, wherein the hollow particle has an apparent density at 20 °C of 0.2 to 0.8 g/cm³.

8. The 3D-printer modeling material according to claim 1, wherein the amount of the hollow particle contained is 1 to 50 parts by mass relative to 100 parts by mass of the total amount of the matrix polymer and the hollow particle contained.

9. A modeled body formed from the 3D-printer modeling material according to claim 1, wherein when the modeled body is measured for shore A hardness in accordance with JIS K 6253-3:2012, the shore A hardness at a time point of 15 seconds from the start of indentation is 61 to 98.

10. The modeled body according to claim 9, wherein the modeled body is a constituent component for an aerial system.

11. The 3D-printer modeling material according to claim 1, wherein the 3D-printer modeling material contains a polylactic acid resin.

12. The 3D-printer modeling material according to claim 5, wherein the cross-linked hollow particle includes a shell formed from a shell polymer containing a cross-linkable monomer unit.

13. The 3D-printer modeling material according to claim 12, wherein the shell polymer contains a bifunctional cross-linkable monomer unit and a tri- or higher cross-linkable monomer unit.

14. The 3D-printer modeling material according to claim 13, wherein the tri- or higher cross-linkable monomer unit contains at least one selected from tri- to hexafunctional cross-linkable monomer units.

15. The 3D-printer modeling material according to claim 12, wherein the shell polymer contains a cross-linkable hydrocarbon monomer unit and a heteroatom-containing cross-linkable monomer unit.

16. A method for forming a modeled body comprising performing 3D-printer modeling by fused deposition modeling using the 3D-printer modeling material according to claim 1.
